(19) United States
(12) Patent Application Publication
(10) Pub. No.: US 2020/0275085 A1
(43) Pub. Date: Aug. 27, 2020

(54) DEVICE FOR FACILITATING RECORDING OF VISUALS FROM MULTIPLE VIEWPOINTS BASED ON SIGNALING

(71) Applicant: Carlos Manuel Guerrero, Bronx, NY (US)

(72) Inventor: Carlos Manuel Guerrero, Bronx, NY (US)

(21) Appl. No.: 16/795,753

(22) Filed: Feb. 20, 2020

Related U.S. Application Data
(60) Provisional application No. 62/808,538, filed on Feb. 21, 2019.

(51) Int. Cl. H04N 13/282; G06F 3/01; G10L 15/08; H04N 13/25; G06K 9/00

(52) U.S. Cl. CPC H04N 13/282; G06F 3/016; G10L 15/083; H04N 2013/0074; G06K 9/00255; G06K 9/00315; H04N 13/25

(57) ABSTRACT

Disclosed herein is a device for facilitating recording of visuals from multiple viewpoints based on signaling. Accordingly, the device may include at least one sensor, a processing device, and a storage device. Further, the at least one sensor may be configured for detecting at least one signal. Further, the at least one sensor may be configured for generating at least one signal data based on the detecting. Further, the processing device may be communicatively coupled with the at least one sensor. Further, the processing device may be configured for analyzing the at least one signal data. Further, the processing device may be configured for generating the control command based on the analyzing. Further, the storage device may be communicatively coupled with the at least one sensor. Further, the storage device may be configured for storing the plurality of visuals.

### RELATED APPLICATION(S)

Under provisions of 35 U.S.C. § 119e, the Applicant(s) claim the benefit of U.S. provisional application No. 62/808,538, titled “Method and System to Facilitate Capturing and Recording of Images, Videos, And Audio”, filed on Feb. 21, 2019 which is incorporated herein by reference.

### TECHNICAL FIELD

Generally, the present disclosure relates to the field of data processing. More specifically, the present disclosure relates to a device for facilitating recording of visuals from multiple viewpoints based on signaling.

### BACKGROUND

Individuals like to capture media, including images, videos, and audios to memorialize events. Further, the individuals also like to view previously captured media, including images and videos to remember events.

Currently, platforms such as social media platforms allow users to view previously posted media to remember events. However, users may not be able to view all previously captured media, including images and videos conveniently.

Therefore, there is a need for an improved device for facilitating recording of visuals from multiple viewpoints based on signaling that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a device for facilitating recording of visuals from multiple viewpoints based on signaling, in accordance with some embodiments. Accordingly, the device may include at least one sensor, a processing device, and a storage device. Further, the at least one sensor may be configured for detecting at least one signal. Further, the at least one sensor may be configured for generating at least one signal data based on the detecting. Further, the at least one sensor may include a plurality of sensors configured for recording a plurality of visuals from a plurality of viewpoints in relation to the device based on a control command. Further, a sensor of the plurality of sensors corresponds to a viewpoint of the plurality of viewpoints. Further, the processing device may be communicatively coupled with the at least one sensor. Further, the processing device may be configured for analyzing the at least one signal data. Further, the processing device may be configured for generating the control command based on the analyzing. Further, the storage device may be communicatively coupled with the at least one sensor. Further, the storage device may be configured for storing the plurality of visuals.

Further disclosed herein is a device for facilitating recording of visuals from multiple viewpoints based on signaling, in accordance with some embodiments. Accordingly, the device may include at least one sensor, a processing device, and a storage device. Further, the at least one sensor may be configured for detecting at least one signal. Further, the at least one sensor may be configured for generating at least one signal data based on the detecting. Further, the at least one sensor may include a plurality of sensors configured for recording a plurality of visuals from a plurality of viewpoints simultaneously in relation to the device based on a control command. Further, a sensor of the plurality of sensors corresponds to a viewpoint of the plurality of viewpoints. Further, the processing device may be communicatively coupled with the at least one sensor. Further, the processing device may be configured for analyzing the at least one signal data. Further, the processing device may be configured for generating the control command based on the analyzing. Further, the storage device may be communicatively coupled with the at least one sensor. Further, the storage device may be configured for storing the plurality of visuals.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a device for facilitating recording of visuals from multiple viewpoints based on signaling, in accordance with some embodiments.

FIG. 3 is a block diagram of the device for facilitating recording of visuals from multiple viewpoints based on signaling, in accordance with some embodiments.

FIG. 4 is a block diagram of the device for facilitating recording of visuals from multiple viewpoints based on signaling, in accordance with some embodiments.

FIG. 5 is a block diagram of a device for facilitating recording of visuals from multiple viewpoints based on signaling, in accordance with some embodiments.

FIG. 6 is a screenshot of a user interface showing a login page of an application to facilitate recording of visuals from multiple viewpoints based on signaling, in accordance with some embodiments.

FIG. 7 is a screenshot of a user interface showing a recording page of the application to facilitate recording of visuals from multiple viewpoints based on signaling, in accordance with some embodiments.

FIG. 8 is a screenshot of a user interface showing a file page of the application to facilitate recording of visuals from multiple viewpoints based on signaling, in accordance with some embodiments.

FIG. 9 is a screenshot of a user interface showing an exemplary recording captured through the application to facilitate recording of visuals from multiple viewpoints based on signaling, in accordance with some embodiments.

FIG. 10 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a device for facilitating recording of visuals from multiple viewpoints based on signaling, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice-based interface, gesture-based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled and/or terminated based on a control input received from one or more devices operated by one or more users such as, for example, but not limited to, an end-user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human-readable secret data (e.g. username, password, passphrase, PIN, secret question, secret answer, etc.) and/or possession of a machine-readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human-readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes a device for facilitating recording of visuals from multiple viewpoints based on signaling. Further, the device may include a web-based software application for facilitating recording and capturing of images, videos, and audio. Further, the web-based software application may be configured to capture and record audio, video, or images.

Further, in some embodiment, the web-based software application may facilitate capturing and recording of images, videos, and audio, and may be called as “Life Record”, and may be used for protection of a user, and for evidence if an event takes place. Information may be securely entered into the “Life Record”. Further, the “Life Record” may be able to record desired events, or moments. Further, the “Life Record” may include a user interface allowing the user to interact through one or more input mechanisms, such as touch input, voice input, gesture-based input, and so on. For instance, using voice input and using a pre-determined phrase such as “Life Record Stop,” the web-based software application may stop recording. Further, using voice input and using a pre-determined phrase, such as, “Life Record Start”, the recording may resume. Further, the web-based software application may be configured to capture and record audio, video, or images. Further, the captured and recorded audio, video, or images may be stored in a database, (such as a cloud database). Further, the captured and recorded audio, video, or images may be stored in the cloud database to minimize the use of local storage associated with the computing device, such as the internal memory of a smartphone. Further, in some embodiment, the recorded and captured audio, video, or images may be called moments.

Further, the moments may be deleted, or captured and shared through external platforms, including multimedia messages, social media platforms, and so on.

Further, with the “Life Record”, the user may be able to find perfect pictures, videos, and recordings of an event. Further, the “Life Record” may also be helpful for the user in recording while driving.

Further, the “Life Record” may allow the user to use multiple cameras on the computing device, such as front and back cameras on a smartphone, and to record simultaneously from the multiple cameras on the computing device. Further, if the computing device is a smartphone, the “Life Record” may allow the user to record simultaneously using both front, and back cameras, even when a lock screen is active on the smartphone.

Further, in an embodiment, the web-based software application may be an offline application, and may not require connection to an external network, such as a mobile network, or the Internet.

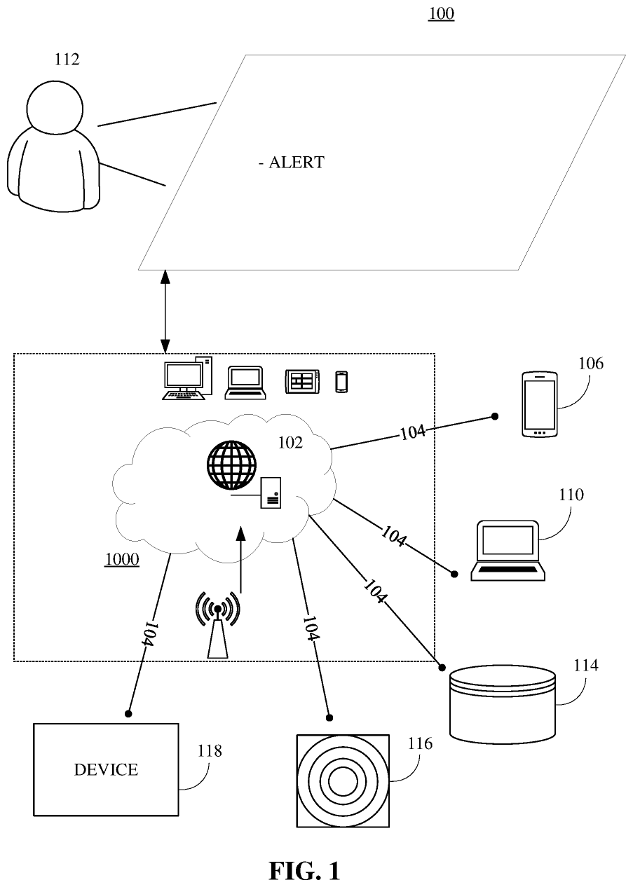

Referring now to figures, FIG. 1 is an illustration of an online platform 100 consistent with various embodiments of the present disclosure. By way of non-limiting example, the online platform 100 to facilitate recording of visuals from multiple viewpoints based on signaling may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, sensors 116, and a device 118 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 1000.

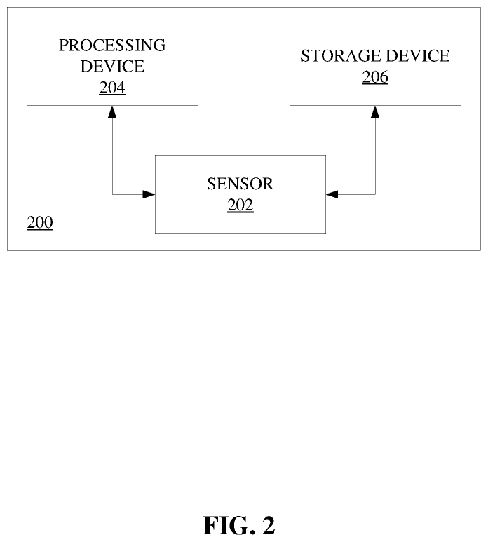

FIG. 2 is a block diagram of a device 200 for facilitating recording of visuals from multiple viewpoints based on signaling, in accordance with some embodiments. Accordingly, the device 200 may include at least one sensor 202, a processing device 204, and a storage device 206.

Further, the at least one sensor 202 may be configured for detecting at least one signal. Further, the at least one sensor 202 may be configured for generating at least one signal data based on the detecting. Further, the at least one signal may include a gesture signal, a sound signal, an expression signal, etc. Further, the gesture signal may be associated with a touch input. Further, the touch input may include a double-tap, a drag, a flick, a pinch, a press and tap, a spread, a press, press and drag, etc. Further, the gesture signal may further include hand motion gestures. Further, the sound signal may include a phrase sample, a voice sample, a speech sample, a music sample, etc. Further, the expression signal may include a facial expression of the at least one user. Further, the facial expression may be associated with a happy face, a sad face, an angry face, a surprised face, a disgusted face, etc. Further, the at least one sensor 202 may include a plurality of sensors configured for recording a plurality of visuals from a plurality of viewpoints in relation to the device 200 based on a control command. Further, a sensor of the plurality of sensors corresponds to a viewpoint of the plurality of viewpoints.

Further, the processing device 204 may be communicatively coupled with the at least one sensor 202. Further, the processing device 204 may be configured for analyzing the at least one signal data. Further, the processing device 204 may be configured for generating the control command based on the analyzing.

Further, the storage device 206 may be communicatively coupled with the at least one sensor 202. Further, the storage device 206 may be configured for storing the plurality of visuals.

Further, in some embodiments, the plurality of sensors may be configured for recording a plurality of sounds corresponding to the plurality of visuals based on the control command. Further, the storage device 206 may be configured for storing the plurality of sounds corresponding to the plurality of visuals.

Further, in some embodiments, the plurality of sensors may be configured for recording the plurality of visuals from the plurality of viewpoints simultaneously based on the control command.

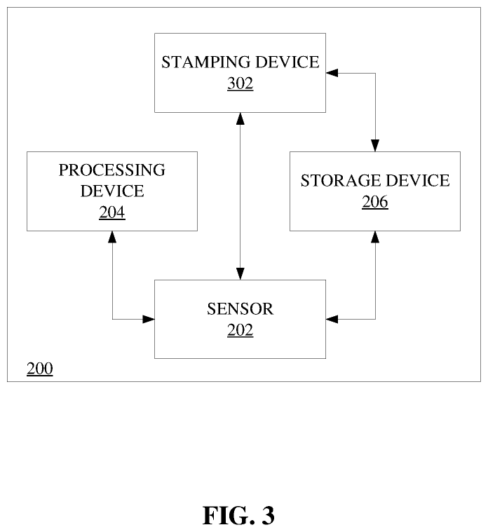

Further, in some embodiments, the device 200 further may include a stamping device 302, as shown in FIG. 3, communicatively coupled with the plurality of sensors. Further, the stamping device 302 may be configured for generating a stamp for the plurality of visuals based on the recording. Further, the stamp may be uniquely characterized by at least one characteristic. Further, the storage device 206 may be communicatively coupled with the stamping device 302. Further, the storage device 206 may be configured for storing the stamp corresponding to the plurality of visuals. Further, in some embodiments, the stamping device 302 may be configured for stamping the plurality of visuals based on the stamp. Further, the stamping device 302 may be configured for generating a plurality of stamped visuals corresponding to the plurality of visuals based on the stamping. Further, the plurality of stamped visuals may be unique. Further, the storage device 206 may be configured for storing the plurality of stamped visuals.

Further, in some embodiments, the at least one sensor 202 may include a microphone. Further, the microphone may be configured for detecting at least one sound. Further, the detecting may include performing at least one of speech analysis, sound analysis, and phrase detecting. Further, the microphone may be configured for generating at least one sound data based on the detecting. Further, the processing device 204 may be configured for analyzing the at least one sound data. Further, the generating of the control command may be based on the analyzing of the at least one sound data.

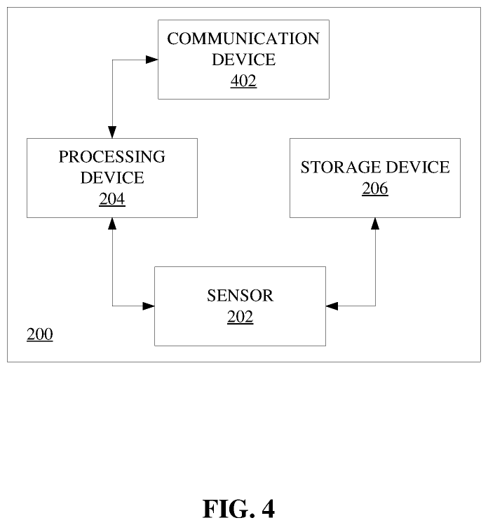

Further, in some embodiments, the device 200 further may include a communication device 402, as shown in FIG. 4, communicatively coupled with the processing device 204. Further, the processing device 204 may be configured for generating an alert based on the analyzing. Further, the communication device 402 may be configured for transmitting the alert to at least one external device.

Further, in some embodiments, each sensor of the plurality of sensors corresponds to each viewpoint of the plurality of viewpoints. Further, the each viewpoint corresponds to an angular field of view in a horizontal plane associated with each sensor. Further, the plurality of sensors associated with the horizontal plane with a plurality of angular field of views corresponding to the plurality of viewpoints may be configured for recording a panoramic visual. Further, the panoramic visual may include a representation of a surrounding of the device 200 from a plurality of angular field of views along the horizontal plane. Further, in some embodiments, each angular field of view of the plurality of angular field of views corresponding to each viewpoint of the plurality of viewpoints overlaps in at least one part for facilitating the plurality of sensors for recording the panoramic visual. Further, in some embodiments, each angular field of view of the plurality of angular field of views corresponding to each viewpoint of the plurality of viewpoints does not overlap for facilitating the plurality of sensors for recording the panoramic visual. Further, in some embodiments, the at least one sensor 202 may include at least one physical state sensor. Further, the at least one physical state sensor may be configured for generating at least one physical state data associated with at least one physical state of the device 200. Further, the at least one physical state may include an orientation state, a tilt state, etc. Further, the orientation state may include a portrait orientation state, landscape orientation state, etc. of the device 200. Further, the tilt state may include tilting the device 200 towards left or right (horizontally), up and down (vertically), etc. Further, the processing device 204 may be configured for analyzing the at least one physical state data. Further, the processing device 204 may be configured for generating state command data based on the analyzing. Further, the plurality of sensors may be configured for aligning the plurality of viewpoints along the horizontal plane based on the state command data.

Further, in some embodiments, the at least one sensor 202 may include at least one face detection sensor. Further, the at least one face detection sensor may be configured for detecting at least one facial expression of at least one user. Further, the at least one face detection sensor may be configured for generating at least one detection data based on the detecting. Further, the processing device 204 may be configured for analyzing the at least one detection data. Further, the generating of the control command may be based on the analyzing of the at least one detection data.

Further, in some embodiments, the at least one sensor 202 may include at least one biological sensor. Further, the at least one biological sensor may be configured for detecting at least one biological activity of at least one user. Further, the at least one biological activity may include releasing of pheromone, etc. Further, the at least one biological sensor may be configured for generating at least one activity data based on the detecting. Further, the processing device 204 may be configured for analyzing the at least one activity data. Further, the generating of the control command may be based on the analyzing of the at least one activity data.

Further, in some embodiments, the at least one sensor 202 may include at least one physiological sensor. Further, the at least one physiological sensor may be configured for detecting at least one physiological variable associated with at least one user. Further, the at least one physiological sensor may be configured for generating at least one physiological data based on the detecting. Further, the processing device 204 may be configured for analyzing the at least one physiological data. Further, the generating of the control command may be based on the analyzing of the at least one physiological data. Further, the at least one physiological variable may include a voluntary physiological variable and an involuntary physiological variable. Further, the voluntary physiological variable may include a respiratory rate, etc. Further, the involuntary physiological variable may include a heart rate, etc.

Further, in some embodiments, the at least one sensor 202 may include at least one respiratory sensor. Further, the at least one respiratory sensor may be associated with a user. Further, the at least one respiratory sensor may be configured for detecting at least one respiratory variable associated with the user. Further, the at least one respiratory sensor may be configured for generating at least one respiratory data based on the detecting. Further, the processing device 204 may be configured for analyzing the at least one respiratory data. Further, the generating of the control command may be based on the analyzing of the at least one respiratory data. Further, the at least one respiratory variable may include a respiratory pattern.

Further, in some embodiments, the at least one sensor 202 may include at least one gesture sensor. Further, the at least one gesture sensor may be configured for detecting at least one gesture of at least one user. Further, the at least one gesture sensor may be configured for generating at least one gesture data based on the detecting. Further, the processing device 204 may be configured for analyzing the at least one gesture data. Further, the generating of the control command may be based on the analyzing of the at least one gesture data.

Further, in some embodiments, the plurality of sensors may include a first sensor and a second sensor. Further, the first sensor and the second sensor are configured for recording a first visual of the plurality of visuals and a second visual of the plurality of visuals from a first viewpoint of the plurality of viewpoints and a second viewpoint of the plurality of viewpoints alternately based on the control command.

Further, in some embodiments, the at least one sensor 202 may be configured for detecting an environment of a user. Further, the environment may include at least one environment variable. Further, the at least one sensor 202 may be configured for generating at least one environment data based on the detecting. Further, the processing device 204 may be configured for analyzing the at least one environment data. Further, the processing device 204 may be configured for inferring at least one state of the user based on the analyzing of the at least one environmental data. Further, the at least one state may include a physiological state. Further, the processing device 204 may be configured for generating the control command based on the inferring. Further, the generating of the plurality of visuals from the plurality of viewpoints is based on the control command. Further, the at least one environment variable may include a spoofy environment, etc.

FIG. 3 is a block diagram of the device 200 for facilitating recording of visuals from multiple viewpoints based on signaling, in accordance with some embodiments.

FIG. 4 is a block diagram of the device 200 for facilitating recording of visuals from multiple viewpoints based on signaling, in accordance with some embodiments.

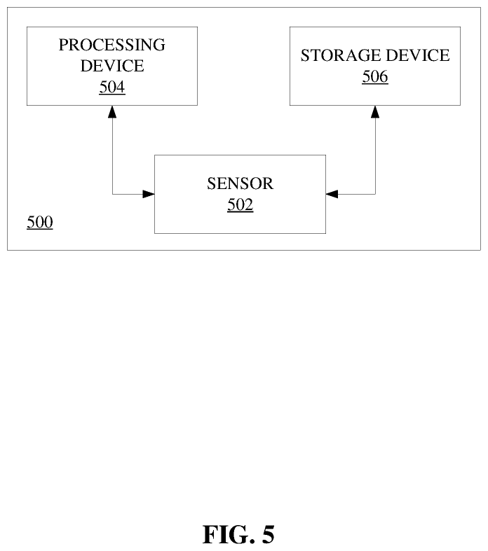

FIG. 5 is a block diagram of a device 500 for facilitating recording of visuals from multiple viewpoints based on signaling, in accordance with some embodiments. Accordingly, the device 500 may include at least one sensor 502, a processing device 504, and a storage device 506.

Further, the at least one sensor 502 may be configured for detecting at least one signal. Further, the at least one sensor 502 may be configured for generating at least one signal data based on the detecting. Further, the at least one signal may include a gesture signal, a sound signal, an expression signal, etc. Further, the gesture signal may be associated with a touch input. Further, the touch input may include a double-tap, a drag, a flick, a pinch, a press and tap, a spread, a press, press and drag, etc. Further, the gesture signal may further include hand motion gestures. Further, the sound signal may include a phrase sample, a voice sample, a speech sample, a music sample, etc. Further, the expression signal may include a facial expression of the at least one user. Further, the facial expression may be associated with a happy face, a sad face, an angry face, a surprised face, a disgusted face, etc. Further, the at least one sensor 502 may include a plurality of sensors configured for recording a plurality of visuals from a plurality of viewpoints simultaneously in relation to the device 500 based on a control command. Further, a sensor of the plurality of sensors corresponds to a viewpoint of the plurality of viewpoints.

Further, the processing device 504 may be communicatively coupled with the at least one sensor 502. Further, the processing device 504 may be configured for analyzing the at least one signal data. Further, the processing device 504 may be configured for generating the control command based on the analyzing.

Further, the storage device 506 may be communicatively coupled with the at least one sensor 502. Further, the storage device 506 may be configured for storing the plurality of visuals.

Further, in some embodiments, the at least one sensor 502 may include a microphone. Further, the microphone may be configured for detecting at least one sound. Further, the detecting may include performing at least one of speech analysis, sound analysis, and phrase detecting. Further, the microphone may be configured for generating at least one sound data based on the detecting. Further, the processing device 504 may be configured for analyzing the at least one sound data. Further, the generating of the control command may be based on the analyzing of the at least one sound data.

Further, in some embodiments, the at least one sensor 502 may include at least one face detection sensor. Further, the at least one face detection sensor may be configured for detecting at least one facial expression of at least one user. Further, the at least one face detection sensor may be configured for generating at least one detection data based on the detecting. Further, the processing device 504 may be configured for analyzing the at least one detection data. Further, the generating of the control command may be based on the analyzing of the at least one detection data.

Further, in some embodiments, the at least one sensor 502 may include at least one biological sensor. Further, the at least one biological sensor may be configured for detecting at least one biological activity of at least one user. Further, the at least one biological activity may include releasing of pheromone, etc. Further, the at least one biological sensor may be configured for generating at least one activity data based on the detecting. Further, the processing device 504 may be configured for analyzing the at least one activity data. Further, the generating of the control command may be based on the analyzing of the at least one activity data.

Further, in some embodiments, the at least one sensor 502 may include at least one gesture sensor. Further, the at least one gesture sensor may be configured for detecting at least one gesture of at least one user. Further, the at least one gesture sensor may be configured for generating at least one gesture data based on the detecting. Further, the processing device 504 may be configured for analyzing the at least one gesture data. Further, the generating of the control command may be based on the analyzing of the at least one gesture data.

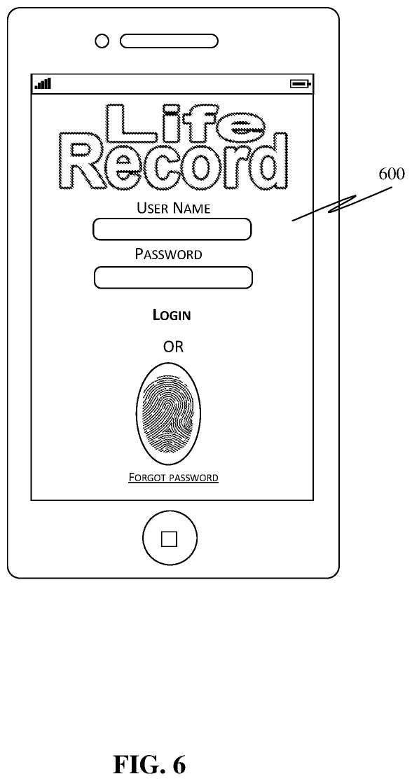

FIG. 6 is a screenshot of a user interface 600 showing a login page of an application to facilitate recording of visuals from multiple viewpoints based on signaling, in accordance with some embodiments. Further, the login page may include a form to allow a user to input a user name, and a password. Further, the login page may allow the user to login using pre-recorded biometric information, such as a fingerprint.

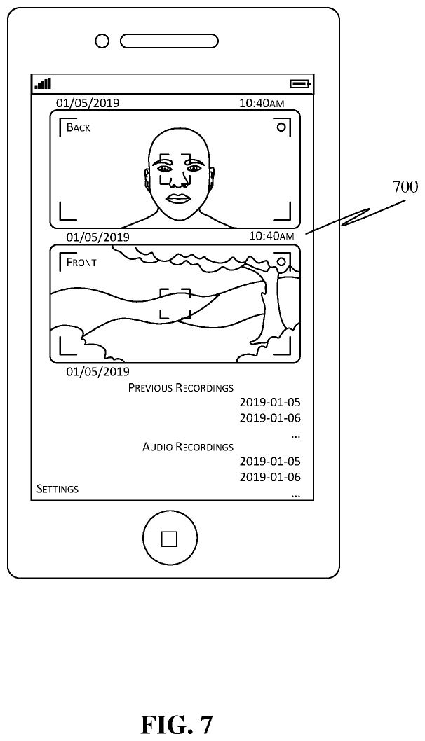

FIG. 7 is a screenshot of a user interface 700 showing a recording page of the application to facilitate recording of visuals from multiple viewpoints based on signaling, in accordance with some embodiments. Further, the recording page may allow a user to capture and record images, videos, and audio. Further, the recording page may allow the user to capture multiple views of an event, such as through multiple cameras, including a front and a back camera of a smartphone. Further, the recording page may display previously captured images, videos, and audio, and may allow the user to view the previously captured images, videos, and audio.

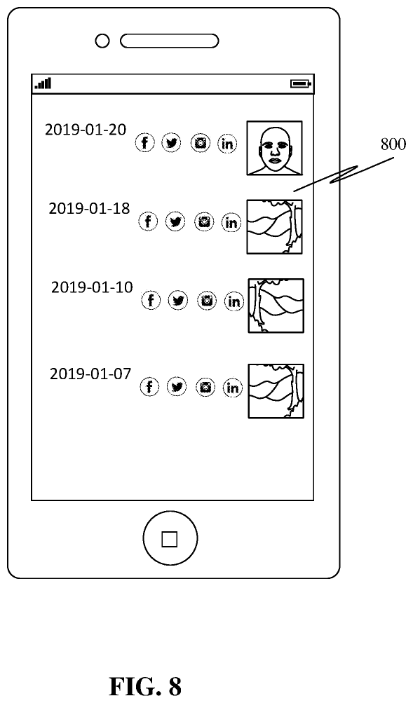

FIG. 8 is a screenshot of a user interface 800 showing a file page of the application to facilitate recording of visuals from multiple viewpoints based on signaling, in accordance with some embodiments. Further, the file page may display previously captured images, videos, and audio, such as a preview, or a snapshot of the previously captured images, videos, and audio. Further, the file page may allow the user to share each of the previously captured images, videos, and audio to external social media platforms, such as Facebook™, Instagram™, Twitter™, LinkedIn™, and so on.

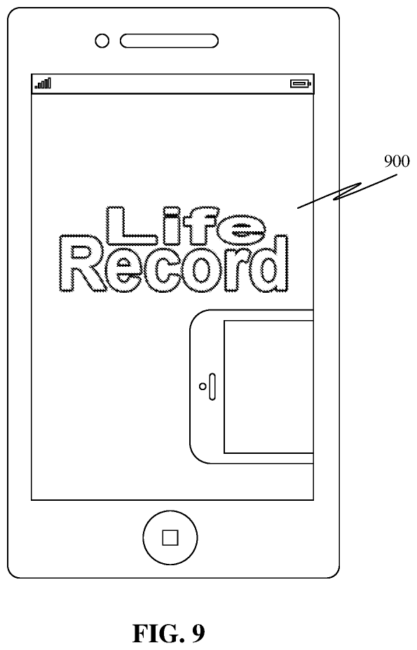

FIG. 9 is a screenshot of a user interface 900 showing an exemplary recording captured through the application to facilitate recording of visuals from multiple viewpoints based on signaling, in accordance with some embodiments.

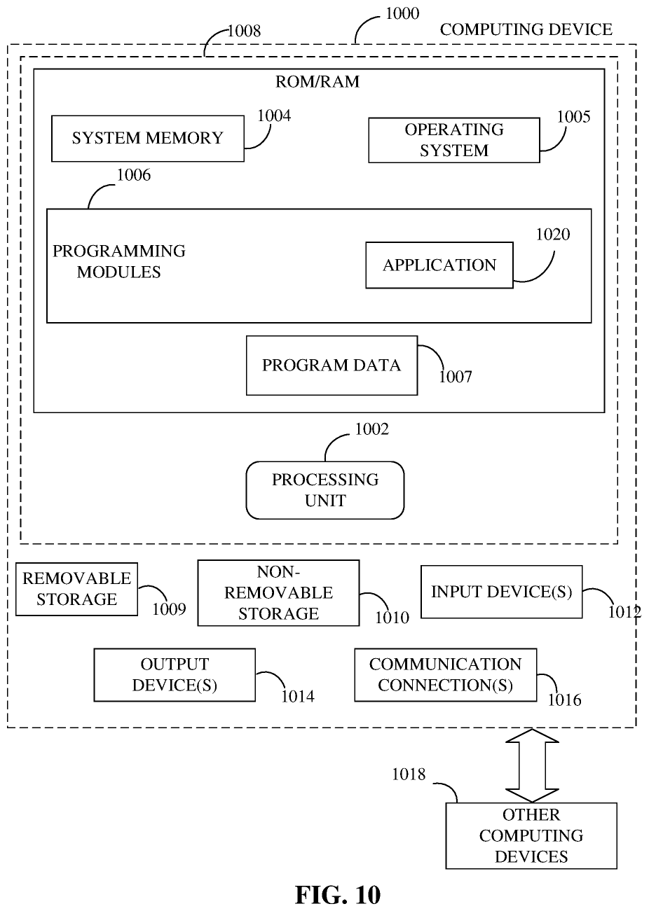

With reference to FIG. 10, a system consistent with an embodiment of the disclosure may include a computing device or cloud service, such as computing device 1000. In a basic configuration, computing device 1000 may include at least one processing unit 1002 and a system memory 1004. Depending on the configuration and type of computing device, system memory 1004 may comprise, but is not limited to, volatile (e.g. random-access memory (RAM)), non-volatile (e.g. read-only memory (ROM)), flash memory, or any combination. The system memory 1004 may include operating system 1005, one or more programming modules 1006, and may include a program data 1007. Operating system 1005, for example, may be suitable for controlling computing device 1000's operation. In one embodiment, programming modules 1006 may include the image-processing module, machine learning module. Furthermore, embodiments of the disclosure may be practiced in conjunction with a graphics library, other operating systems, or any other application program and is not limited to any particular application or system. This basic configuration is illustrated in FIG. 10 by those components within a dashed line 1008.

Computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010. Computer storage media may include volatile and non-volatile, removable and non-removable media implemented in any method or technology for storage of information, such as computer-readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1000. Any such computer storage media may be part of device 1000. Computing device 1000 may also have input device(s) 1012 such as a keyboard, a mouse, a pen, a sound input device, a touch input device, a location sensor, a camera, a biometric sensor, etc. Output device(s) 1014 such as a display, speakers, a printer, etc. may also be included. The aforementioned devices are examples and others may be used.

Computing device 1000 may also contain a communication connection 1016 that may allow device 1000 to communicate with other computing devices 1018, such as over a network in a distributed computing environment, for example, an intranet or the Internet. Communication connection 1016 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1004, including operating system 1005. While executing on processing unit 1002, programming modules 1006 (e.g., application 1020 such as a media player) may perform processes including, for example, one or more stages of methods, algorithms, systems, applications, servers, databases as described above. The aforementioned process is an example, and processing unit 1002 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A device for facilitating recording of visuals from multiple viewpoints based on signaling, the device comprising:
at least one sensor configured for:
detecting at least one signal; and
generating at least one signal data based on the detecting, wherein the at least one sensor comprises a plurality of sensors configured for recording a plurality of visuals from a plurality of viewpoints in relation to the device based on a control command, wherein a sensor of the plurality of sensors corresponds to a viewpoint of the plurality of viewpoints;
a processing device communicatively coupled with the at least one sensor, wherein the processing device is configured for:
analyzing the at least one signal data; and
generating the control command based on the analyzing; and
a storage device communicatively coupled with the at least one sensor, wherein the storage device is configured for storing the plurality of visuals.

2. The device of claim 1, wherein the plurality of sensors is configured for recording a plurality of sounds corresponding to the plurality of visuals based on the control command, wherein the storage device is configured for storing the plurality of sounds corresponding to the plurality of visuals.

3. The device of claim 1, wherein the plurality of sensors is configured for recording the plurality of visuals from the plurality of viewpoints simultaneously based on the control command.

4. The device of claim 1 further comprising a stamping device communicatively coupled with the plurality of sensors, wherein the stamping device is configured for generating a stamp for the plurality of visuals based on the recording, wherein the stamp is uniquely characterized by at least one characteristic, wherein the storage device is communicatively coupled with the stamping device, wherein the storage device is configured for storing the stamp corresponding to the plurality of visuals.

5. The device of claim 4, wherein the stamping device is configured for:
stamping the plurality of visuals based on the stamp; and
generating a plurality of stamped visuals corresponding to the plurality of visuals based on the stamping, wherein the plurality of stamped visuals is unique, wherein the storage device is configured for storing the plurality of stamped visuals.

6. The device of claim 1, wherein the at least one sensor comprises a microphone, wherein the microphone is configured for:
detecting at least one sound, wherein the detecting comprises performing at least one of speech analysis, sound analysis, and phrase detecting; and
generating at least one sound data based on the detecting, wherein the processing device is configured for analyzing the at least one sound data, wherein the generating of the control command is based on the analyzing of the at least one sound data.

7. The device of claim 1 further comprising a communication device communicatively coupled with the processing device, wherein the processing device is configured for generating an alert based on the analyzing, wherein the communication device is configured for transmitting the alert to at least one external device.

8. The device of claim 1, wherein each sensor of the plurality of sensors corresponds to each viewpoint of the plurality of viewpoints, wherein the each viewpoint corresponds to an angular field of view in a horizontal plane associated with each sensor, wherein the plurality of sensors associated with the horizontal plane with a plurality of angular field of views corresponding to the plurality of viewpoints is configured for recording a panoramic visual, wherein the panoramic visual comprises a representation of a surrounding of the device from a plurality of angular field of views along the horizontal plane.

9. The device of claim 8, wherein each angular field of view of the plurality of angular field of views corresponding to each viewpoint of the plurality of viewpoints overlaps in at least one part for facilitating the plurality of sensors for recording the panoramic visual.

10. The device of claim 8, wherein each angular field of view of the plurality of angular field of views corresponding to each viewpoint of the plurality of viewpoints does not overlap for facilitating the plurality of sensors for recording the panoramic visual.

11. The device of claim 8, wherein the at least one sensor comprises at least one physical state sensor, wherein the at least one physical state sensor is configured for generating at least one physical state data associated with at least one physical state of the device, wherein the processing device is configured for:
analyzing the at least one physical state data; and
generating state command data based on the analyzing, wherein the plurality of sensors is configured for aligning the plurality of viewpoints along the horizontal plane based on the state command data.

12. The device of claim 1, wherein the at least one sensor comprises at least one face detection sensor, wherein the at least one face detection sensor is configured for:
detecting at least one facial expression of at least one user; and
generating at least one detection data based on the detecting, wherein the processing device is configured for analyzing the at least one detection data, wherein the generating of the control command is based on the analyzing of the at least one detection data.

13. The device of claim 1, wherein the at least one sensor comprises at least one biological sensor, wherein the at least one biological sensor is configured for:
detecting at least one biological activity of at least one user; and
generating at least one activity data based on the detecting, wherein the processing device is configured for analyzing the at least one activity data, wherein the generating of the control command is based on the analyzing of the at least one activity data.

14. The device of claim 1, wherein the at least one sensor comprises at least one gesture sensor, wherein the at least one gesture sensor is configured for:
detecting at least one gesture of at least one user; and
generating at least one gesture data based on the detecting, wherein the processing device is configured for analyzing the at least one gesture data, wherein the generating of the control command is based on the analyzing of the at least one gesture data.

15. The device of claim 1, wherein the plurality of sensors comprises a first sensor and a second sensor, wherein the first sensor and the second sensor are configured for recording a first visual of the plurality of visuals and a second visual of the plurality of visuals from a first viewpoint of the plurality of viewpoints and a second viewpoint of the plurality of viewpoints alternately based on the control command.

16. A device for facilitating recording of visuals from multiple viewpoints based on signaling, the device comprising:
at least one sensor configured for:
detecting at least one signal; and
generating at least one signal data based on the detecting, wherein the at least one sensor comprises a plurality of sensors configured for recording a plurality of visuals from a plurality of viewpoints simultaneously in relation to the device based on a control command, wherein a sensor of the plurality of sensors corresponds to a viewpoint of the plurality of viewpoints;
a processing device communicatively coupled with the at least one sensor, wherein the processing device is configured for:
analyzing the at least one signal data; and
generating the control command based on the analyzing; and
a storage device communicatively coupled with the at least one sensor, wherein the storage device is configured for storing the plurality of visuals.

17. The device of claim 16, wherein the at least one sensor comprises a microphone, wherein the microphone is configured for:
detecting at least one sound, wherein the detecting comprises performing at least one of speech analysis, sound analysis, and phrase detecting; and
generating at least one sound data based on the detecting, wherein the processing device is configured for analyzing the at least one sound data, wherein the generating of the control command is based on the analyzing of the at least one sound data.

18. The device of claim 16, wherein the at least one sensor comprises at least one face detection sensor, wherein the at least one face detection sensor is configured for:
detecting at least one facial expression of at least one user; and
generating at least one detection data based on the detecting, wherein the processing device is configured for analyzing the at least one detection data, wherein the generating of the control command is based on the analyzing of the at least one detection data.

19. The device of claim 16, wherein the at least one sensor comprises at least one biological sensor, wherein the at least one biological sensor is configured for:
detecting at least one biological activity of at least one user; and
generating at least one activity data based on the detecting, wherein the processing device is configured for analyzing the at least one activity data, wherein the generating of the control command is based on the analyzing of the at least one activity data.

20. The device of claim 16, wherein the at least one sensor comprises at least one gesture sensor, wherein the at least one gesture sensor is configured for:
detecting at least one gesture of at least one user; and
generating at least one gesture data based on the detecting, wherein the processing device is configured for analyzing the at least one gesture data, wherein the generating of the control command is based on the analyzing of the at least one gesture data.
